(19) United States
(12) Patent Application Publication
(10) Pub. No.: US 2019/0178754 A1
(43) Pub. Date: Jun. 13, 2019

(54) METHOD AND SYSTEM FOR MONITORING STRUCTURAL STATUS OF RAILCAR DRAFT GEAR

(71) Applicant: Jiaxing Broadsens Technology, Ltd., Jiaxing (CN)

(72) Inventors: Chang Zhang, San Jose, CA (US); Lei Liu, San Ramon, CA (US)

(73) Assignee: Jiaxing Broadsens Technology, Ltd., Jiaxing (CN)

(21) Appl. No.: 16/211,232

(22) Filed: Dec. 6, 2018

Related U.S. Application Data
(60) Provisional application No. 62/596,683, filed on Dec. 8, 2017.

(51) Int. Cl. G01M 17/08; B61G 7/00

(52) U.S. Cl. CPC G01M 17/08; B61G 9/08; B61G 7/00

(57) ABSTRACT

The present invention discloses a method for monitoring status of a railcar draft gear in an assembly. The assembly comprises the draft gear and a coupler. At least one accelerometer or strain sensor is installed. The at least one accelerometer is configured to measure acceleration or deceleration of the coupler. The at least one strain sensor is configured to measure strain exerted on the coupler. Data collected on the acceleration or deceleration, or the strain is analyzed by algorithms to ascertain status of the draft gear.

### CROSS-REFERENCE TO RELATED APPLICATION

This application claims priority to U.S. provisional patent application Ser. No. 62/596,683, filed Dec. 8, 2017, the entire content of which is incorporated herein by reference.

### FIELD OF INVENTION

This invention generally relates to railcar draft gear and specifically to monitoring status of a railcar draft gear.

### BACKGROUND OF THE INVENTION

Typical railcars, such as railcars 101 and 102 shown in FIGS. 1.1 and 1.2, are connected end to end by couplers. For instance, railcar 101 has couplers 103 and 107 and railcar 102 has couplers 104 and 108. In FIG. 1.2, the two railcars are coupled to each other by couplers 103 and 104. To absorb shocks, usually a draft gear, functioning as a buffer or cushion, is placed between a coupler and a railcar. Draft gears, such as draft gears 105 and 109 installed on railcar 101 and draft gears 106 and 110 installed on railcar 102, are designed to reduce longitudinal impact during train operations like acceleration and braking. Draft gears may contain a hydraulic cushioning assembly, a spring assembly, an elastomeric cushioning assembly, or other shock-absorbing assemblies. FIG. 2.1 shows an exemplary prior-art assembly 200 that has a coupler 201 and a draft gear 202. Coupler 201 and draft gear 202 are connected by a mechanical structure (not shown in the figure). Draft gear 202 contains a hydraulic cushioning assembly. When the hydraulic cushioning assembly is pressed from the right hand side, e.g., in a braking process, coupler 201 may push a bar 203 of the draft gear to the left. Bar 203 in turn presses fluid 204 inside a cylinder and advances a distance D, as illustrated in FIG. 2.2. Distance D represents a position change of the draft gear and may be called stroke length or travel distance of the draft gear. The larger the force which pushes bar 203 to the left, the longer bar 203 travels and the larger the value of D.

A draft gear becomes degraded when its cushioning structure experiences fatigue or defects in the structure. For instance, a hydraulic cushioning assembly is subject to leaks, which may significantly degrade its performance; and a spring assembly or an elastomeric cushioning assembly may have fatigue issues or defect growth issues. Draft gear degrading or failure may cause damages to the lading and the railcars, because it lets the longitudinal forces be transmitted to the railcars without being dampened. Thus, railcar draft gears play an important role in railway transportation, especially for high-load freight trains and high-speed trains. It is critical to keep draft gears in healthy conditions.

Because a draft gear is usually hidden inside a housing of a coupler assembly and taking a draft gear out of a housing is time consuming and labor intensive, direct inspection of draft gears is not routinely performed during scheduled maintenance sessions. Also, current maintenance methods mainly employ visual inspections. As a visual inspection is conducted by observing the outside of a coupler assembly, it is difficult to detect any abnormality of a draft gear before an issue becomes severe. Hence, it is hard to find a problematic draft gear early enough to prevent any incident from happening. For instance, defective draft gears may already cause damages when there is a big leak from a hydraulic cushioning system or a draft gear is way off its neutral position. Thus, it is important to detect a faulty draft gear at an early stage to avoid compromising the safety of the lading and the railcars. Therefore, there is a need for a new method to monitor status of a railcar draft gear without taking it out of a housing component.

### SUMMARY OF THE INVENTION

The present invention discloses a method to monitor status of a railcar draft gear in an assembly. In one embodiment, the assembly also includes a coupler. At least one sensor is installed to measure acceleration or deceleration of the assembly. Alternatively, at least one sensor is installed to measure strain exerted on the draft gear. Collected acceleration/deceleration or strain data is analyzed to ascertain the status of the draft gear. The monitoring process may be performed in real time while railcars are in service.

In one embodiment, an accelerometer is installed to measure acceleration or deceleration of the assembly. The measurement data is used to monitor status of the draft gear.

In another embodiment, a force/load sensor or strain gauge is installed to measure strain exerted on the draft gear. The measurement data is used to monitor status of the draft gear.

In another embodiment, multiple accelerometers or multiple force/load sensors or strain gauges are installed to measure acceleration or deceleration of the assembly or strain exerted on the draft gear. The measurement data is used to monitor status of the draft gear.

In yet another embodiment, data on acceleration or deceleration or strain is collected when the draft gear is in normal status. The data is then used to construct baseline data as a reference for detecting underperformance of the draft gear and its status.

In yet another embodiment, additional sensors such as a temperature sensor, a humidity sensor, a pressure sensor, a speed sensor, and/or an orientation senor are installed to measure environmental conditions and detect the draft gear's status in more details. Consequently, additional data is acquired and used to create more comprehensive baseline data.

In yet another embodiment, an accelerometer is installed to measure acceleration or deceleration of the assembly, a force/load sensor or strain gauge is installed to measure strain exerted on the draft gear, and a displacement sensor is installed to measure position changes of the draft gear. The measurement data on acceleration or deceleration, strain, and position changes is used to monitor status of the draft gear.

In yet another embodiment, machine learning algorithms are used to process data on acceleration or deceleration, strain, and/or position changes. The machine learning algorithms are employed to construct baseline data and detect underperformance of the draft gear and its status.

In yet another embodiment, artificial neural networks are used to process data on acceleration or deceleration, strain, and/or position changes. The artificial neural networks are employed to construct baseline data, define threshold values, and detect underperformance of the draft gear and its status.

The present invention has advantages of monitoring status of draft gears continuously whether inspections are carried out online or offline and whether railcars are in service or out of service. Thus, defective draft gears may be detected at an early stage to avoid damages on the lading and the rail cars.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the leftmost digit of a reference number identifies the drawing in which the reference number first appears.

FIGS. 1.1 and 1.2 illustrates prior art railcars in side views;

FIGS. 2.1 and 2.2 illustrates cross-sectional views of a prior art assembly containing a coupler and a draft gear;

FIG. 3 illustrates a cross-sectional view of an assembly containing a coupler and a draft gear, according to one embodiment of the present invention;

FIG. 4 illustrates a cross-sectional view of an assembly containing a coupler and a draft gear, according to one embodiment of the present invention;

FIG. 5 illustrates a cross-sectional view of an assembly containing a coupler and a draft gear, according to one embodiment of the present invention;

FIG. 6 illustrates a cross-sectional view of an assembly containing a coupler and a draft gear, according to one embodiment of the present invention;

FIG. 7 illustrates a cross-sectional view of an assembly containing a coupler and a draft gear, according to one embodiment of the present invention; and

FIG. 8 illustrates an exemplary block diagram of a data collection and processing unit of a monitoring system, according to one embodiment of the present invention.

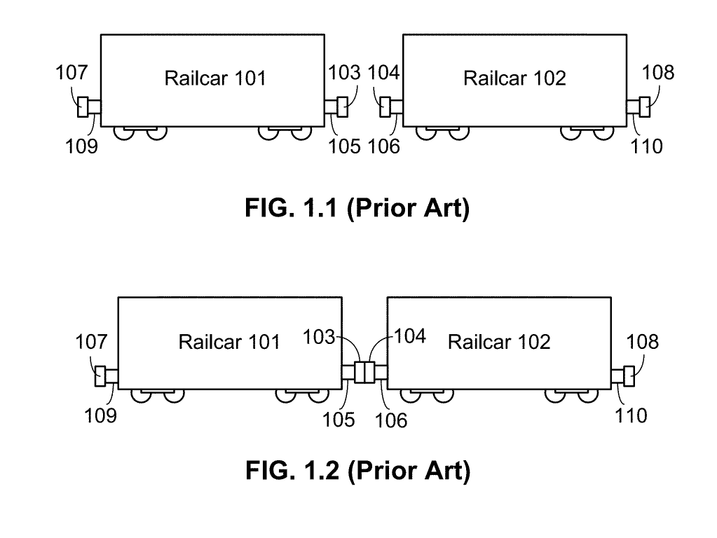

### DETAILED DESCRIPTION

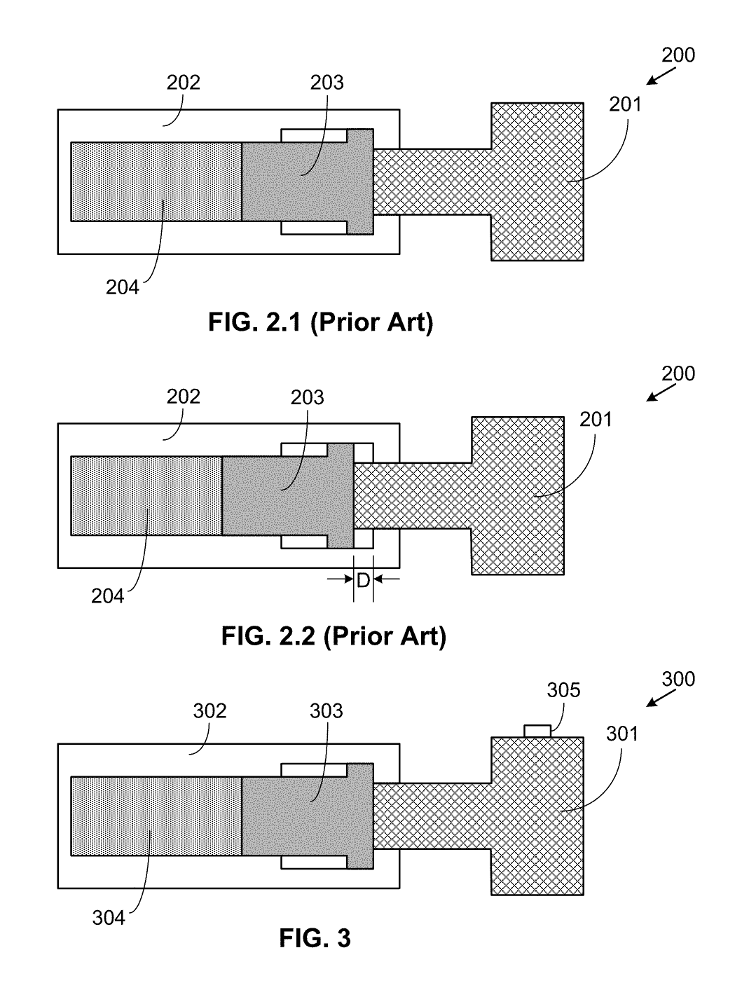

FIG. 3 illustrates an exemplary assembly 300 in a cross-sectional view, according to one embodiment of the present invention. Assembly 300 includes a coupler 301 and a draft gear 302. Assembly 300 has a similar structure to that shown in FIGS. 2.1 and 2.2. The difference is that an accelerometer 305 is added and mounted on the assembly (e.g., on the coupler 301). Accelerometer 305 may have one axis, two axes, or three axes to measure acceleration or deceleration of the assembly 300 in one, two, or three directions. Accelerometer 305 may be integrated as part of assembly 300. Alternatively, the assembly 300 only includes a draft gear and the accelerometer is installed on the draft gear to measure its acceleration or deceleration directly.

Referring back to the embodiment in FIG. 3, draft gear 302 dampens impact forces by making certain displacement, such as moving a bar 303 and letting it travel a distance. Movement of bar 303 absorbs shocks when railcars are pulling, pushing, or stopping. When a draft gear is operating in a normal condition, the force exerted on the draft gear cause displacement of the draft gear, e.g., causing certain travel distance of the bar 303. When the assembly is in a normal status, data may be collected, by measurements and calculation, to create a set of baseline data. The baseline data shows values of acceleration or deceleration of the assembly in certain patterns.

If a draft gear structure is defective, data on the acceleration or deceleration shows a different pattern from the baseline values. For instance, when leakage of fluid 304 occurs at draft gear 302, there are different acceleration/deceleration values from baseline data and bar 303 travels a longer distance. Consequently, a railcar connected to draft gear 302 may experience more severe shocks. Thus, degraded draft gears may damage the lading and railcars and a faulty draft gear may be detected by analyzing data on acceleration or deceleration of the assembly (or the draft gear itself) by comparing measurement data to the baseline values. Additionally, threshold values may be defined. If the difference between measurement data and baseline data is below a corresponding threshold value, the draft gear structure may be considered in normal state. If the difference is beyond the corresponding threshold, the draft gear structure may be considered in abnormal or defective state.

As discussed, at least one accelerometer may be installed and used to monitor status of a railcar draft gear. The accelerometer measures acceleration when the railcar is gaining speed or deceleration when the railcar is braking. The accelerometer may also be used to detect vibration when the railcar travels at a constant speed. The vibration is mainly caused by interaction between wheels of the railcar and the rail tracks and interaction among moving parts on train bogies.

In one embodiment after acceleration data is collected, the data is filtered to remove environment noise. The noise may come but not limited from power supply, Electromagnetic Interference (EMI) from nearby cables or inductors, and Radio Frequency Interference (RFI) from wireless or cellular signals. A digital low pass filter may be used to remove the high frequency noise. Alternatively, moving average method may be used to smooth the signal and remove unwanted high frequency components. Other methods such as Discrete Fourier Transform (DFT) may be used to remove high frequency noise as well.

Then, a pattern recognition method is used to extract features from the filtered acceleration data. Assume that the filtered acceleration signal is f(k), k=1, . . . , N. In one embodiment, the signal feature may be the energy of the filtered data in the given window. Assume that the window contains n points. Then the feature may be obtained by the following formula:

Eₙ=Σᵢ₌ⱼ^{n+j}f(i)*f(i),

where En is the energy of the chosen window, j is the starting point of the window, n is the size of the window.

The window may be a period when the railcar is gaining speed, a period when the railcar is reaching stable speed, a period when the railcar is reducing speed, or combination of the cases.

In another embodiment, the feature may be the energy of the envelope of acceleration due to multiple vibrations. The signal envelope may be obtained by methods such as Hilbert Huang Transform.

In yet another embodiment, the feature may be the parameters from the frequency domain such as the energy at a given frequency range. The features when a draft gear is in normal status may be used as the baseline to check status of a draft gear. Hence, after acceleration data is obtained via an accelerometer, the data is filtered and then its features are extracted. The extracted features are compared with baseline data to ascertain whether a draft gear under monitoring is in normal conditions or whether the draft gear needs repair or replacement.

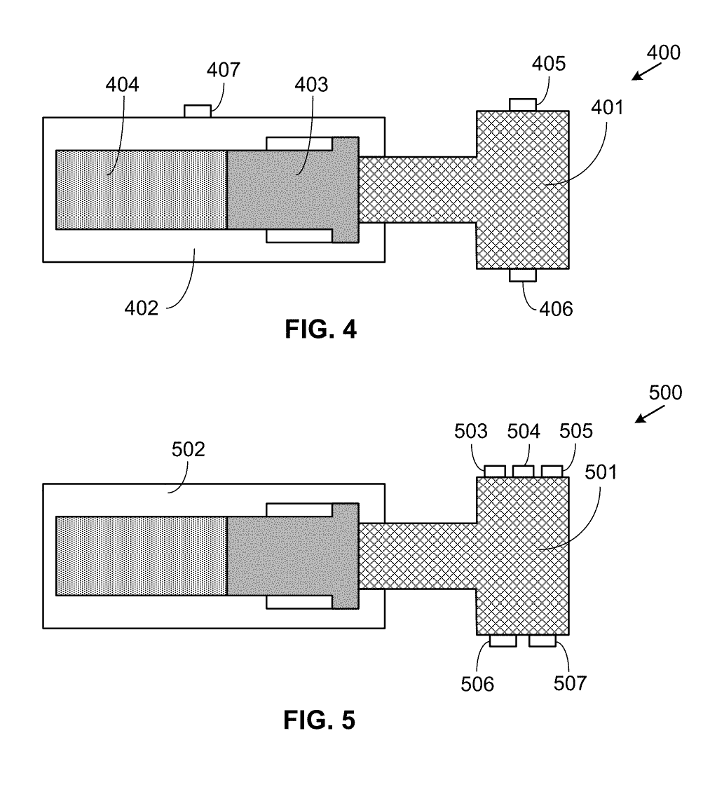

FIG. 4 illustrates an exemplary assembly 400 in a cross-sectional view, according to one embodiment of the present invention. Assembly 400 comprises a coupler 401, a draft gear 402, and accelerometers 406 and 407. Comparing with assembly 300, assembly 400 has the same coupler and draft gear structures but has one more accelerometer. Accelerometers 406 and 407 may be mounted on the opposite surfaces of the coupler 401. As a result, two sets of acceleration data are obtained. Both sets of data may be used to construct baseline data and ascertain status of a draft gear. Extra set of measurement data and baseline data may improve detection accuracy and reliability of the monitoring system. In a different embodiment, the assembly 400 only includes a draft gear and the multiple accelerometers are directly installed on the draft gear.

Referring back to the embodiment in FIG. 4, an extra accelerometer 407 may be mounted on the draft gear 402 directly. Accelerometer 407 may be used to measure acceleration or deceleration of draft gear 402 when a bar 403 is in compression and pressing fluid 404. Data collected by accelerometer 407, reflecting status of draft gear 402 from another angle, may be used to generate one more set of baseline data. The extra baseline data may further improve measurement accuracy of the draft gear status and reliability of the monitoring system.

FIG. 5 illustrates an exemplary assembly 500 in a cross-sectional view, according to one embodiment of the present invention. Assembly 500 comprises a coupler 501, a draft gear 502, at least one accelerometer, plus multiple environmental sensors and other status sensors. For simplicity reasons, the accelerometer is not shown in the figure. The environmental sensors and other status sensors may comprise a temperature sensor 503, a humidity sensor 504, a pressure sensor 505, a speed sensor 506, and an orientation senor 507. Temperature sensor 503 measures ambient temperature. Humidity sensor 504 measures humidity of the ambient air. Pressure sensor 505 measures the atmospheric pressure. Speed sensor 506 measures speed of the coupler or draft gear. Orientation sensor 507, such as an electronic compass, measures orientation of the coupler or the draft gear. The environmental and status sensors may be mounted on coupler 501 and/or draft gear 502. Data on temperature, humidity, and pressure may be used to calibrate measurement results on acceleration or deceleration. Speed and orientation data may provide more information about the coupler and the draft gear, which may be used to build more comprehensive baseline data.

In addition, a speed senor may be installed on a railcar (not shown in the figure). Speed measurement of the railcar may be used to improve the accuracy as well. For example, when the railcar reaches a stable speed, vibration signal at a speed range, e.g., from v−α to v+α, may be used for the window selection, where v is the railcar speed, α is used to define the window size.

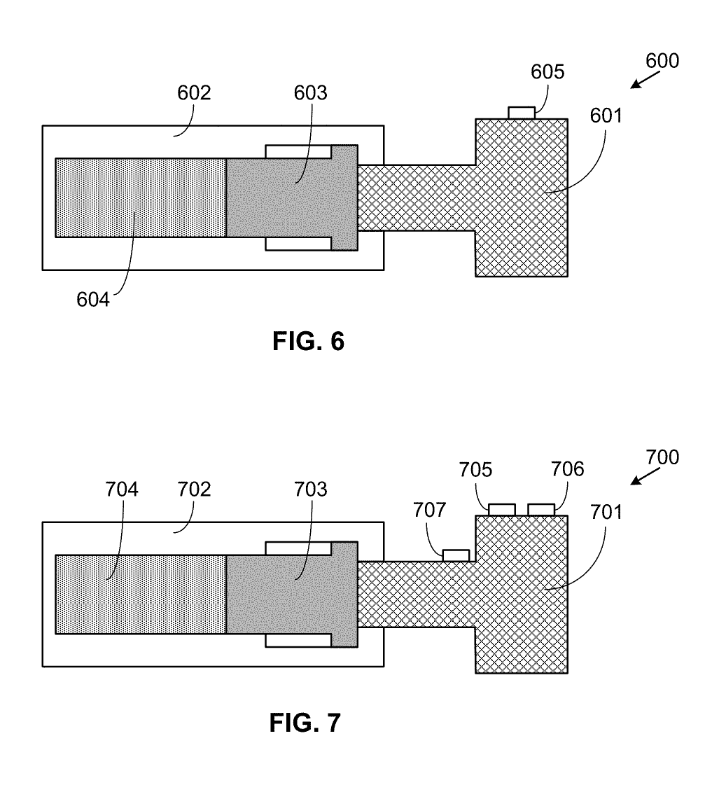

Alternatively, status of a draft gear may also be detected by monitoring strain exerted on the draft gear as shown in FIG. 6. Illustrated in FIG. 6 is an exemplary assembly 600 in a cross-sectional view, according to one embodiment of the present invention. Assembly 600 comprises a coupler 601, a draft gear 602, and a strain gauge 605. Assembly 600 has a similar structure to assembly 300 shown in FIG. 3. The change is that strain gauge 605, mounted on coupler 601, replaces accelerometer 305. Strain gauge 605 may be integrated as part of assembly 600. Strain gauge 605 measures strain experienced by coupler 601. A force, which is applied on coupler 601, causes the strain. A strain gauge may have one grid or multiple grids depending on application needs. In a different embodiment, the assembly only includes the draft gear and the strain gauge is installed on the draft gear directly for measuring the strain exerted on the draft gear directly.

When a railcar draft gear is in normal conditions, strain signals are recorded. The strain reaches the maximum value when a coupler, which is connected to the draft gear, is pushed to the limit. The strain has the minimum value when the coupler is pulled to the limit. Each rising edge or falling edge between these peaks indicates one push-pull cycle of the draft gear. The peak-to-peak values of the strain depend on the damping ratio of the draft gear and may indicate status of the draft gear. The signal features from a strain gauge may be but not limited to the following:

[fₘᵢₙ ⁱ,f_{avg}ⁱ,fₘₐₓⁱ], i=1,2,3, . . . , N

where fₘᵢₙⁱ, f_{avg}ⁱ, fₘₐₓⁱ stand for the minimum, average and maximum peak-to-peak value of strain sensor i respectively, and N is the number of strain gauges. To extract the signal features, the edge points which denote the rising and falling edges may be found by moving a small window through the signal, and then the peak points may be found and the peak-to-peak value for each edge points may be calculated.

Different conditions of the features extracted represent different classes of “patterns” and indicate the status of the draft gear. Pattern recognition techniques, which are able to distinguish between different patterns, are applied in detection processes. Various pattern recognition techniques such as artificial neural networks (ANN) and support vector machine (SVM) may be used. ANN, as biologically inspired artificial intelligence representations, may be used for mimicking the functionality of neural systems. Feedforward neural networks consist of several fully-connected layers which compute the output directly from the input. Each layer of the ANN computes the following transformation:

xₗ=g(Wₗ·x₁₋ₗ+bₗ), l=1, 2, . . . , N

where Wₗ and bₗ are the learnable weight matrix and the bias of the l^{th} layer respectively and g(.) is the activation function. A popular Rectified Linear Unit (ReLU) may be used as the activation function from layer 1 to layer N−1. x₀ is the initial input of the whole network, which is generated by concatenating the signal features from all the stain gauges.

The output of the last layer is fed into a softmax layer to generate the distribution on several possible states of the draft gear.

ReLU(x)=max(0,x)

ANN are trained with the data when a draft gear is in normal conditions. During a monitoring process, measurement data is fed into the ANN to show status of the draft gear.

Therefore, like an accelerometer, a strain gauge may be installed on a coupler to monitor status of a draft gear. Moreover, aforementioned methods to improve measurement accuracy and reliability may be used too, as described in the following embodiments.

In one embodiment, a second strain gauge may be installed on the assembly, for instance, on a surface opposite to strain gauge 606. The second strain gauge measures strain exerted on the draft gear and provides another set of strain data. The extra data sets may be used to generate extra baseline data and extra data which improve measurement accuracy and reliability.

In another embodiment, a temperature sensor, a humidity sensor, a pressure sensor, a speed sensor, and an orientation sensor may be installed the assembly. The sensors may play the same roles as they do in FIG. 5. Data on temperature, humidity, and pressure may be used to calibrate measurement results on strain. Speed and orientation data may provide more information about the coupler and the draft gear, which may be used to build more comprehensive baseline data.

Aside from using an accelerometer or a strain sensor, status of a railcar draft gear may also be monitored by a combination of at least one accelerometer, at least one strain sensor, and at least one displacement sensor. For instance, FIG. 7 illustrates an exemplary assembly 700 in a cross-sectional view, according to one embodiment of the present invention. Assembly 700 comprises a coupler 701 and a draft gear 702. In addition, an accelerometer 705, a strain sensor 706, and a displacement sensor 707 are mounted on the assembly (e.g., the coupler 701). Accelerometer 705 measures acceleration or deceleration of the assembly in one, two, or three directions. Strain gauge 706 measures strain experienced by the draft gear indirectly. In a different embodiment, the assembly only includes a draft gear and the accelerometer, strain sensor, and displacement sensor are installed on the draft gear for direct measurement of the draft gear's acceleration/deceleration, strain, and displacement.

A force, which is exerted on coupler 701, may be determined by a value of the strain and a lookup table or a mathematical model. The force applied to coupler 701 may also be measured directly using a force sensor or load sensor. A force or load sensor may be based on resistance measurement, piezoelectric effect, or hydraulic mechanism. Since a force sensor or a load sensor has a much larger size plus an intrusion issue compared to a strain gauge, they have limited application cases.

Displacement sensor 707 is employed to measure position changes of the draft gear, e.g., travel distance of a bar 703 when the draft gear receives compression forces in a braking process. Displacement or position changes of a draft gear may be detected utilizing the Hall effect or capacitive measurements. The displacement or position changes may also be detected by optical or ultrasonic methods. For instance, laser beams or ultrasonic waves may be utilized to measure the distance between sensor 707 and the housing of draft gear 702, assuming sensor 707 has a laser or an ultrasonic source. In addition, a string potentiometer may be installed on couple 701 to measure position changes of the draft gear as well.

When a draft gear has normal status, the force exerted on the coupler and the acceleration or deceleration of the coupler cause displacement of the draft gear, e.g., certain travel distance of bar 703. Thus, data on acceleration or deceleration, strain, and displacement may be collected when a draft gear is in normal status. The collected data may be used to create baseline data and threshold values. Then status of a railcar draft gear may be monitored via comparing measurement results with the baseline data and the threshold values.

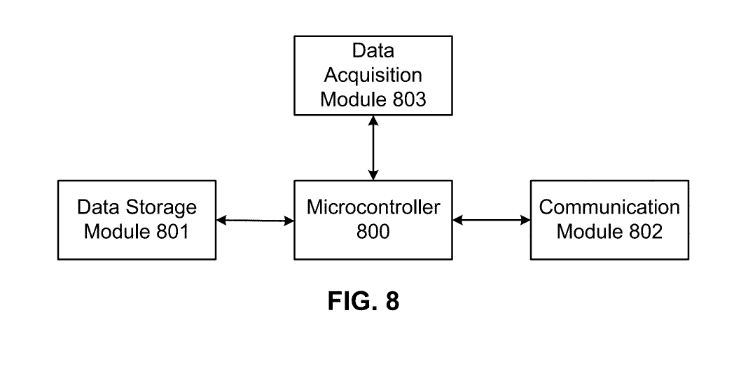

FIG. 8 is an exemplary block diagram of a control and data processing unit of a draft gear monitoring system. A microcontroller 800 may monitor status of one or more railcar draft gears by algorithms. It controls the monitoring system via a software or program. Microcontroller 800 controls measurements, manages measurement results, calibrates raw data, and determines status of one or more draft gears. A data storage module 801 is used to store measurement data, calibrated data, baseline data, and threshold values. A communication module 802 may include a network interface. Via module 802, the monitoring system may communicate with a remote server, send measurement results, and receive instructions to schedule and perform measurements. A data acquisition module 803 is connected to sensors installed on a coupler and draft gear and passes measurement data to microcontroller 800 for further processing. Microcontroller 800 and modules 801, 802, and 803 may be discrete devices. Alternatively, the microcontroller and the modules may also be integrated into one device. Microcontroller 800 and modules 801, 802, and 803 may be mounted on a coupler, a draft gear, or a railcar.

Moreover, machine learning algorithms may be used to create baseline data and ascertain the status of a draft gear. The machine learning algorithms may include three types: supervised, unsupervised, and reinforcement. The algorithms may analyze big data collected at various occasions, optimize baseline data, and enhance the capabilities to detect a defective draft gear through continuous improvement.

Furthermore, ANN may be also used to ascertain the status of a draft gear based on acceleration or deceleration data. Artificial neural networks may derive the meanings from complicated or imprecise data. This ability may be utilized for extracting patterns of baseline data, patterns of data when a draft gear is defective in certain conditions, and defining more accurate threshold values.

Lastly, data on acceleration or deceleration, strain, and/or displacement may be used to construct a status model. The model may output status of a railcar draft gear.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method for monitoring status of a railcar draft gear in an assembly, comprising:
obtaining sensor data from at least one of an accelerometer installed on the assembly for detecting acceleration or deceleration of the assembly and a strain sensor installed on the assembly for detecting strain exerted on the draft gear; and
processing the sensor data to determine the status of the railcar draft gear.

2. The method of claim 1 further comprises constructing a set of baseline data based on sensor data obtained when the draft gear is in a normal state.

3. The method of claim 2, wherein the sensor data comprises acceleration or deceleration data and said processing step comprises comparing the acceleration or deceleration data with the set of baseline data to determine whether the status of the railcar draft gear is normal.

4. The method of claim 2, wherein the sensor data comprises strain data and said processing step comprises comparing the strain data with the set of baseline data to determine whether the status of the railcar draft gear is normal.

5. The method of claim 1, wherein the at least one of an accelerometer and a strain sensor is integrated as part of the assembly.

6. The method of claim 1, wherein the processing step uses machine learning method in analyzing the sensor data.

7. The method of claim 1, wherein the processing step uses neural network model in analyzing the sensor data.

8. The method of claim 1 further comprises using at least one of temperature data, humidity data, altitude data, speed data, inclination data, and orientation data obtained from additional sensors installed on the assembly to determine the status of the railcar draft gear.

9. The method of claim 1 further comprises obtaining data on position changes of the draft gear from a displacement sensor installed on the assembly, wherein the data on position changes is processed to determine the status of the railcar draft gear.

10. A system for monitoring status of a railcar draft gear in an assembly, comprising:
at least one of an accelerometer for detecting acceleration or deceleration of the assembly and a strain sensor for detecting strain exerted on the draft gear; and
a processor for processing data obtained from the at least an accelerometer and strain sensor to determine the status of the railcar draft gear.

11. The system of claim 10 further comprises at least one of a temperature sensor, a humidity sensor, a pressure sensor, a speed sensor, and an orientation senor, and wherein the processor further processes data obtained from the at least one of a temperature sensor, a humidity sensor, a pressure sensor, a speed sensor, and an orientation senor to determine the status of the railcar draft gear.

12. The system of claim 10, wherein the processor uses data collected from the at least one of an accelerometer and a strain sensor as baseline when the assembly is at a normal status.

13. The system of claim 10, wherein the processor uses one of a machine learning method and artificial neural network for said processing.

14. The system of claim 10 further comprises at least one displacement sensor to be installed on the assembly for detecting position changes of the draft gear, wherein data on position changes of the draft gear is processed to determine the status of the railcar draft gear.
